(19) United States
(12) Patent Application Publication
(10) Pub. No.: US 2021/0041671 A1
(43) Pub. Date: Feb. 11, 2021

(54) Optical Lens Assembly

(71) Applicants: Sintai Optical (Shenzhen) Co., Ltd., ShenZhen City (CN); Asia Optical Co., Inc., Taichung (TW)

(72) Inventors: Fang-Li Ma, ShenZhen City (CN); Bin Liu, ShenZhen City (CN); Yue-Ye Chen, ShenZhen City (CN); Hua-Tang Liu, Taichung (TW)

(21) Appl. No.: 16/930,493

(22) Filed: Jul. 16, 2020

(30) Foreign Application Priority Data
Aug. 6, 2019 (CN) 201910720342.3

(51) Int. Cl. G02B 13/00; G02B 9/64; G02B 27/00

(52) U.S. Cl. CPC G02B 13/0045; G02B 27/0025; G02B 9/64

(57) ABSTRACT

An optical lens assembly includes a first lens, a second lens, a third lens, a fourth lens, a fifth lens, a sixth lens, and a seventh lens, all of which are arranged in order from an object side to an image side along an optical axis. The first lens comprises a convex surface facing an image side. The second lens is with positive refractive power and comprises a convex surface facing an object side. The third lens is meniscus lens with refractive power. The fourth lens is meniscus lens with refractive power. The fifth lens is with negative refractive power and comprises a concave surface facing the object side. The sixth lens is meniscus lens with refractive power. The seventh lens is meniscus lens with positive refractive power.

### BACKGROUND OF THE INVENTION

### Field of the Invention

The invention relates to an optical lens assembly.

### Description of the Related Art

LiDAR (Light Detection and Ranging) uses short pulse laser with a wavelength of 905 nm to measure the target distance. Because of high resolution, LiDAR can completely depict the contour of the target so as to meet the sensing requirements of farther and more accuracy for self-driving cars. Therefore, LiDAR is currently widely used in the field of vehicle ranging. In accordance with different targets and applications, the optical lens assembly used in LiDAR needs to have large field of view, miniaturization and small wavefront aberration. However, the known optical lens assembly can't satisfy such requirements. Therefore, the optical lens assembly needs a new structure in order to meet the requirements of large field of view, miniaturization and small wavefront aberration at the same time.

### BRIEF SUMMARY OF THE INVENTION

The invention provides an optical lens assembly to solve the above problems. The optical lens assembly of the invention is provided with characteristics of a shortened total lens length, an increased field of view, a decreased wavefront aberration, and still has a good optical performance.

The optical lens assembly in accordance with an exemplary embodiment of the invention includes a first lens, a second lens, a third lens, a fourth lens, a fifth lens, a sixth lens, and a seventh lens, all of which are arranged in order from an object side to an image side along an optical axis. The first lens is with positive refractive power and comprises a convex surface facing the image side. The second lens is with positive refractive power and comprises a convex surface facing the object side. The third lens is a meniscus lens with refractive power. The fourth lens is with refractive power and comprises a convex surface facing the object side and a concave surface facing the image side. The fifth lens is with negative refractive power and comprises a concave surface facing the object side. The sixth lens is a meniscus lens with refractive power. The seventh lens is a meniscus lens with positive refractive power.

The optical lens assembly in accordance with another exemplary embodiment of the invention includes a first lens, a second lens, a third lens, a fourth lens, a fifth lens, a sixth lens, and a seventh lens, all of which are arranged in order from an object side to an image side along an optical axis. The first lens comprises a convex surface facing the image side. The second lens is with positive refractive power and comprises a convex surface facing the object side. The third lens is a meniscus lens with refractive power. The fourth lens is a meniscus lens with refractive power. The fifth lens is with negative refractive power and comprises a concave surface facing the object side. The sixth lens is with refractive power and comprises a concave surface facing the object side and a convex surface facing the image side. The seventh lens is with positive refractive power and comprises a convex surface facing an image side.

In another exemplary embodiment, the optical lens assembly satisfies, 86.45 degrees≤FOV≤95.55 degrees, where FOV is a field of view of the optical lens assembly.

In yet another exemplary embodiment, the optical lens assembly satisfies, where any one of the Nd₁, Nd₂, Nd₃, Nd₄ Nd₆ and Nd₇ is greater than the Nd₅; and 23.75%≤AOE/AOI≤26.25%; wherein Nd₁ is an index of refraction of the first lens, Nd₂ is an index of refraction of the second lens, Nd₃ is an index of refraction of the third lens, Nd₄ is an index of refraction of the fourth lens, Nd₅ is an index of refraction of the fifth lens, Nd₆ is an index of refraction of the sixth lens, Nd₇ is an index of refraction of the seventh lens, AOI is an angle of incidence of the optical lens assembly, and AOE is an angle of emergence of the optical lens assembly.

In another exemplary embodiment, the optical lens assembly satisfies, 3.8≤f₅₆₇/f₁₂₃₄≤4.2, where f₁₂₃₄ is an effective focal length of a combination of the first lens, the second lens, the third lens and the fourth lens and f₅₆₇ is an effective focal length of a combination of the fifth lens, the sixth lens, and the seventh lens.

In yet another exemplary embodiment, the first lens comprises a concave surface facing the object side, the second lens comprises a convex surface facing the image side; and the third lens is with positive refractive power and comprises a convex surface facing the object side and a concave surface facing the image side.

In another exemplary embodiment, the fourth lens is with positive refractive power, the sixth lens is with positive refractive power and comprises a concave surface facing the object side and a convex surface facing the image side; and the seventh lens comprises a concave surface facing the object side and a convex surface facing the image side.

In yet another exemplary embodiment, the fifth lens further comprises a concave surface facing the image side.

In another exemplary embodiment, the fifth lens further comprises a plane surface facing the image side.

In yet another exemplary embodiment, the first lens is with positive refractive power and comprises a concave surface facing the object side, the second lens comprises a convex surface facing the image side; and the third lens is with positive refractive power and comprises a convex surface facing the object side and a concave surface facing the image side.

In another exemplary embodiment, the fourth lens is with positive refractive power and comprises a convex surface facing the object side and a concave surface facing the image side, the sixth lens is with positive refractive power; and the seventh lens comprises a concave surface facing the object side.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout and optical path diagram of an optical lens assembly in accordance with a first embodiment of the invention;

FIG. 2A depicts a wavefront function diagram at an incident angle is equal to 0.00 degrees for the optical lens assembly in accordance with the first embodiment of the invention;

FIG. 2B is a wavefront function diagram at an incident angle is equal to 27.3 degrees for the optical lens assembly in accordance with the first embodiment of the invention;

FIG. 2C is a wavefront function diagram at an incident angle is equal to 45.5 degrees for the optical lens assembly in accordance with the first embodiment of the invention;

FIG. 2D is a wavefront function diagram at an incident angle is equal to 64.34 degrees for the optical lens assembly in accordance with the first embodiment of the invention;

FIG. 2E is a wavefront function diagram at an incident angle is equal to 77.36 degrees for the optical lens assembly in accordance with the first embodiment of the invention;

FIG. 2F is a wavefront function diagram at an incident angle is equal to 91 degrees for the optical lens assembly in accordance with the first embodiment of the invention;

FIG. 3 is a lens layout and optical path diagram of a optical lens assembly in accordance with a second embodiment of the invention; and

FIG. 4 is a lens layout and optical path diagram of a optical lens assembly in accordance with a third embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides an optical lens assembly including a first lens, a second lens, a third lens, a fourth lens, a fifth lens, a sixth lens, and a seventh lens. The first lens is with positive refractive power and comprises a convex surface facing an image side. The second lens is with positive refractive power and comprises a convex surface facing an object side. The third lens is a meniscus lens with refractive power. The fourth lens is with refractive power and comprises a convex surface facing the object side and a concave surface facing the image side. The fifth lens is with negative refractive power and comprises a concave surface facing the object side. The sixth lens is a meniscus lens with refractive power. The seventh lens is a meniscus lens with positive refractive power. The first lens, the second lens, the third lens, the fourth lens, the fifth lens, the sixth lens, and the seventh lens are arranged in order from the object side to the image side along an optical axis.

The present invention provides another optical lens assembly including a first lens, a second lens, a third lens, a fourth lens, a fifth lens, a sixth lens, and a seventh lens. The first lens comprises a convex surface facing an image side. The second lens is with positive refractive power and comprises a convex surface facing an object side. The third lens is a meniscus lens with refractive power. The fourth lens is a meniscus lens with refractive power. The fifth lens is with negative refractive power and comprises a concave surface facing the object side. The sixth lens is with refractive power and comprises a concave surface facing the object side and a convex surface facing the image side. The seventh lens is with positive refractive power and comprises a convex surface facing an image side. The first lens, the second lens, the third lens, the fourth lens, the fifth lens, the sixth lens, and the seventh lens are arranged in order from the object side to the image side along an optical axis.

Referring to Table 1, Table 2, Table 4, Table 5, Table 7, and Table wherein Table 1, Table 4, and Table 7 show optical specifications in accordance with a first, second, and third embodiments of the invention respectively and Table 2, Table 5, and Table 8 show aspheric coefficients of each aspheric lens in Table 1, Table 4, and Table 7 respectively.

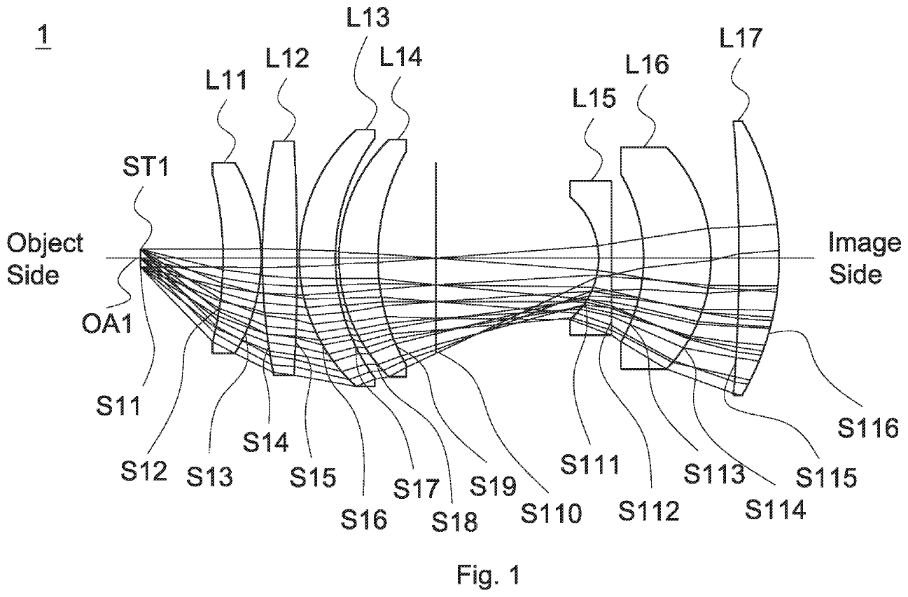

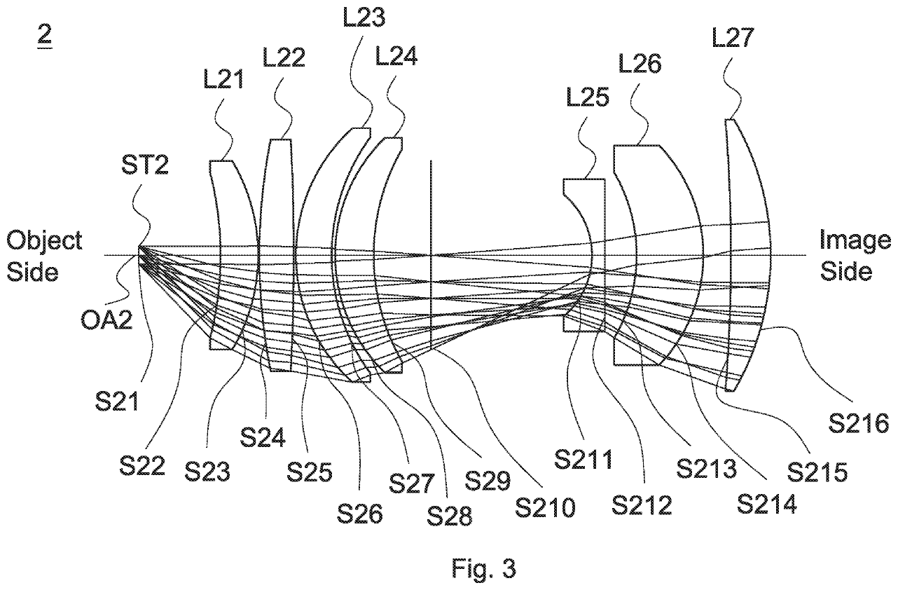

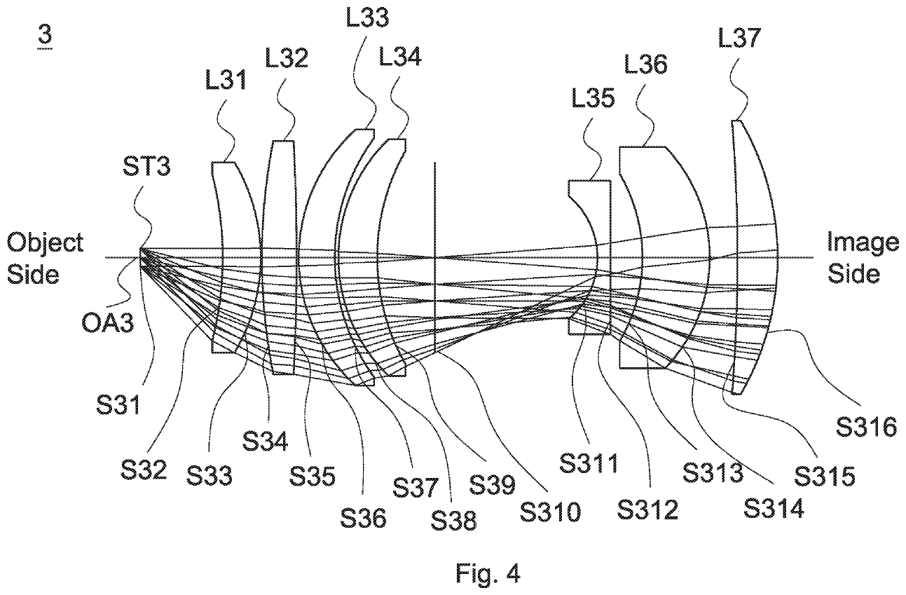

FIG. 1, FIG. 3, and FIG. 4 are lens layout and optical path diagrams of the optical lens assembly in accordance with the first, second, and third embodiments of the invention respectively.

The first lens L11, L21, L31 are meniscus lenses with positive refractive power and made of glass material, wherein the object side surface S12, S22, S32 are concave surfaces, the image side surface S13, S23, S33 are convex surfaces, and the object side surface S12, S22, S32 and the image side surface S13, S23, S33 are spherical surfaces.

The second lens L12, L22, L32 are biconvex lenses with positive refractive power and made of glass material, wherein the object side surface S14, S24, S34 and the image side surface S15, S25, S35 are convex surfaces, and the object side surface S14, S24, S34 and the image side surface S15, S25, S35 are spherical surfaces.

The third lens L13, L23, L33 are meniscus lenses with positive refractive power and made of glass material, wherein the object side surface S16, S26, S36 are convex surfaces, the image side surface S17, S27, S37 are concave surfaces and the object side surface S16, S26, S36 and the image side surface S17, S27, S37 are spherical surfaces.

The fourth lens L14, L24, L34 are meniscus lenses with positive refractive power and made of glass material, wherein the object side surface S18, S28, S38 are convex surfaces, the image side surface S19, S29, S39 are concave surface and the object side surface S18, S28, S38 and the image side surface S19, S29, S39 are spherical surfaces.

The fifth lens L15, L25, L35 are with negative refractive power and made of glass material, wherein the object side surface S111, S211, S311 are concave surface and the object side surface S111, S211, S311 are aspheric surfaces.

The sixth lens L16, L26, L36 are meniscus lenses with positive refractive power and made of glass material, wherein the object side surface S113, S213, S313 are concave surfaces, the image side surface S114, S214, S314 are convex surface and the object side surface S113, S213, S313 and the image side surface S114, S214, S314 are spherical surfaces.

The seventh lens L17, L27, L37 are meniscus lenses with positive refractive power and made of glass material, wherein the object side surface S115, S215, S315 are concave surfaces, the image side surface S116, S216, S316 are convex surface and the object side surface S115, S215, S315 and the image side surface S116, S216, S316 are spherical surfaces.

In addition, the optical lens assembly 1, 2, 3 satisfy at least one of the following conditions:

86.45 degree≤FOV≤95.55 degree; (1)

Nd₁>Nd₅; (2)

Nd₂>Nd₅; (3)

Nd₃>Nd₅; (4)

Nd₄>Nd₅; (5)

Nd₆>Nd₅; (6)

Nd₇>Nd₅; (7)

23.75%≤AOE/AOI≤26.25% (8)

3.8≤f₅₆₇/f₁₂₃₄≤4.2; (9)

wherein FOV is a field of view of the optical lens assembly 1, 2, 3 for the first to third embodiments, AOI is an angle of incidence of the optical lens assembly 1, 2, 3 for the first to third embodiments, AOE is an angle of emergence of the optical lens assembly 1, 2, 3 for the first to third embodiments, Nd₁ is an index of refraction of the first lens L11, L21, L31 for the first to third embodiments, Nd₂ is an index of refraction of the second lens L12, L22, L32 for the first to third embodiments, Nd₃ is an index of refraction of the third lens L13, L23, L33 for the first to third embodiments, Nd₄ is an index of refraction of the fourth lens L14, L24, L34 for the first to third embodiments, Nd₅ is an index of refraction of the fifth lens L15, L25, L35 for the first to third embodiments, Nd₆ is an index of refraction of the sixth lens L16, L26, L36 for the first to third embodiments, Nd₇ is an index of refraction of the seventh lens L17, L27, L37 for the first to third embodiments, f₁₂₃₄ is an effective focal length of a combination of the first lens L11, L21, L31, the second lens L12, L22, L32, the third lens L13, L23, L33 and the fourth lens L14, L24, L34 of the optical lens assembly 1, 2, 3 for the first to third embodiments, f₅₆₇ is an effective focal length of a combination of the fifth lens L15, L25, L35, the sixth lens L16, L26, L36, and the seventh lens L17, L27, L37 of the optical lens assembly 1, 2, 3 for the first to third embodiments. Making the optical lens assembly 1, 2, 3 can effectively shorten the total lens length, effectively increase field of view, effectively increase angle of incidence, effectively reduce angle of emergence, effectively reduce wavefront aberration, and effectively correct aberration. It will be appreciated that the upper limit and lower limit of the above conditions can be adjusted by a person skilled in the art within a reasonable tolerance range, wherein the reasonable tolerance range is ±5%.

A detailed description of an optical lens assembly in accordance with a first embodiment of the invention is as follows. Referring to FIG. 1, the optical lens assembly 1 includes a stop ST1, a first lens L11, a second lens L12, a third lens L13, a fourth lens L14, a fifth lens L15, a sixth lens L16 and a seventh lens L17, all of which are arranged in order from an object side to an image side along an optical axis OAI. In operation, a laser beam from the object side passes through the optical ens assembly 1 which leads spot size of the laser beam to be four times.

According to paragraphs [0030]-[40037], wherein: the fifth lens L15 is a plane-convex lens, wherein the image side surface S112 is a plane surface.

With the above design of the lenses and stop ST1 and at least any one of the conditions (1)-(9) satisfied, the optical lens assembly 1 can have an effectively shorten the total lens length, effectively increase field of view, effectively increase angle of incidence, effectively reduce angle of emergence, effectively reduce wavefront aberration, and effectively correct aberration.

Table 1 shows the optical specification of the optical lens assembly 1 in FIG. 1.

TABLE 1
Total Lens Length = 126.84 mm
Field of View = 91 Degrees
F-number = 1.62

| | | | | | Effec- | |
|---|---|---|---|---|---|---|
| | | | | | tive | |
| | Radius of | Thick- | | | Focal | |
| Surface | Curvature | ness | | | Length | |
| Number | (mm) | (mm) | Nd | Vd | (mm) | Remark |
| S11 | ∞ | 18.855 | | | | Stop ST1 |
| S12 | −81.88 | 8.80 | 2.00069 | 25.44 | 77.519 | The First |
| | | | | | | Lens L11 |
| S13 | −41.23 | 0.20 | | | | |
| S14 | 128.49 | 8.00 | 2.00069 | 25.44 | 108.729 | The Second |
| | | | | | | Lens L12 |
| S15 | −564.79 | 0.38 | | | | |
| S16 | 39.19 | 8.40 | 2.00069 | 25.44 | 166.363 | The Third |
| | | | | | | Lens L13 |
| S17 | 46.33 | 0.84 | | | | |
| S18 | 37.67 | 8.64 | 2.00069 | 25.44 | 122.630 | The Fourth |
| | | | | | | Lens L14 |
| S19 | 48.95 | 13.3692 | | | | |
| S110 | ∞ | 37.06 | | | | Dummy |
| | | | | | | surface |
| S111 | −18.109 | 3.00 | 1.58913 | 61.16 | −31.233 | The Fifth |
| | | | | | | Lens L15 |
| S112 | ∞ | 7.22 | | | | |
| S113 | −39.03 | 15.32 | 2.00069 | 25.44 | 154.285 | The Sixth |
| | | | | | | Lens L16 |
| S114 | −36.92 | 6.5 | | | | |
| S115 | −406.58 | 9.11 | 2.00069 | 25.44 | 73.922 | The Seventh |
| | | | | | | lens L17 |
| S116 | −61.53 | 100 | | | | |

The aspheric surface sag z of each aspheric lens in table 1 can be calculated by the following formula:

z=ch²/{1+[1−(k+1)c²h²]^{1/2}}+Ah⁴+Bh⁶+Ch⁸+Dh¹⁰

where c is curvature, h is the vertical distance from the lens surface to the optical axis, k is conic constant and A, B, C and D are aspheric coefficients.

In the first embodiment, the conic constant k and the aspheric coefficients A, B, C, D of each aspheric surface are shown in Table 2.

TABLE 2

| Surface | | | | | |
|---|---|---|---|---|---|
| Number | k | A | B | C | D |
| S111 | −0.10218 | −1.331E−006 | 4.008E−009 | −2.627E−011 | 1.311E−013 |

Table 3 shows the parameters and condition values for conditions (1)-(9) in accordance with the first embodiment of the invention. It can be seen from Table 3 that the optical lens assembly 1 of the first embodiment satisfies the conditions (1)-(9).

TABLE 3

| | | | | | | |
|---|---|---|---|---|---|---|
| AOI | 91 | degrees | AOE | 22.75 degrees | f₁₂₃₄ | 25.74 mm |
| f₅₆₇ | 101.36 | mm | | | | |

| | | | |
|---|---|---|---|
| AOE/ | 25% | f₅₆₇/f₁₂₃₄ | 3.94 |
| AOI | | | |

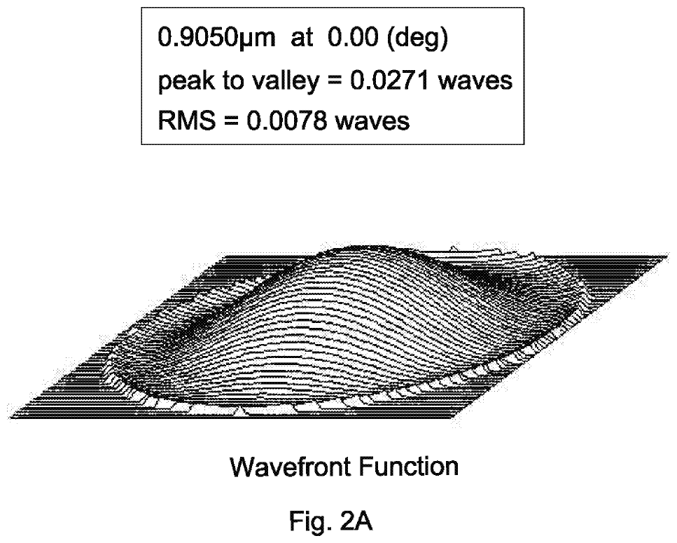

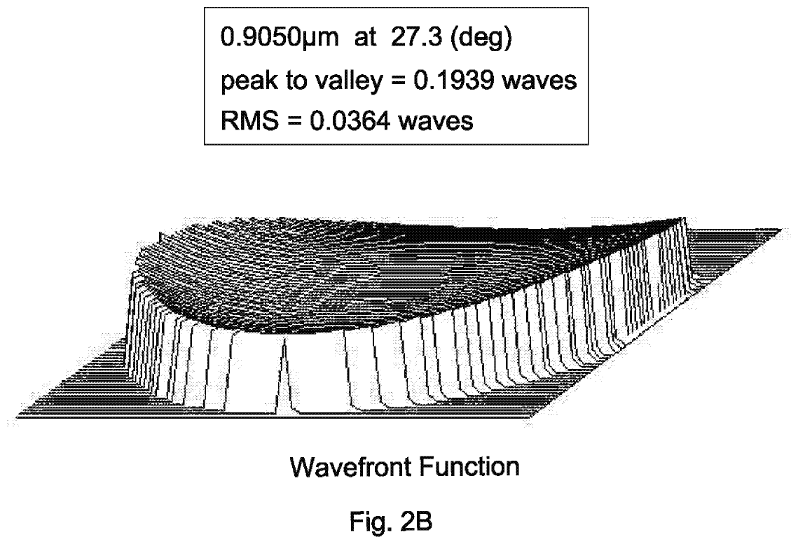

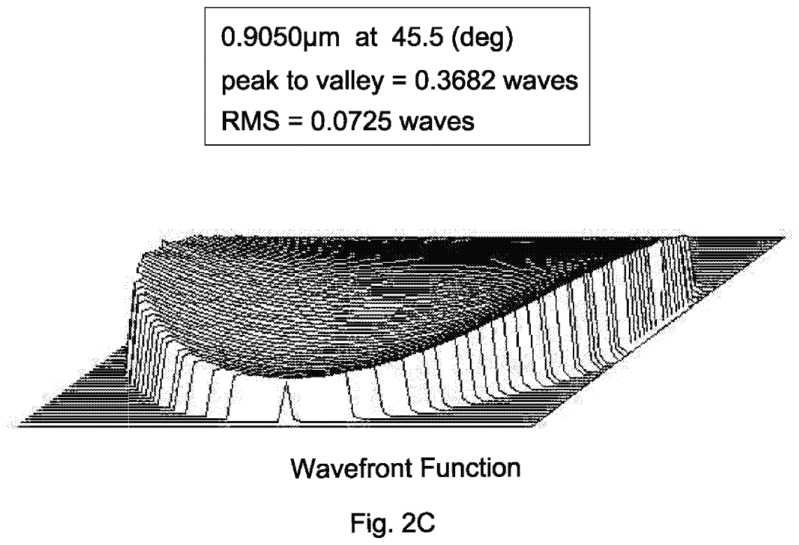

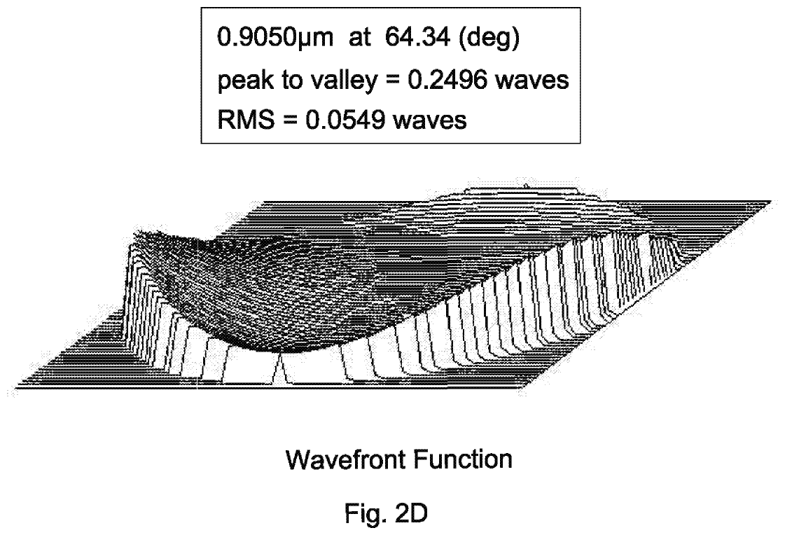

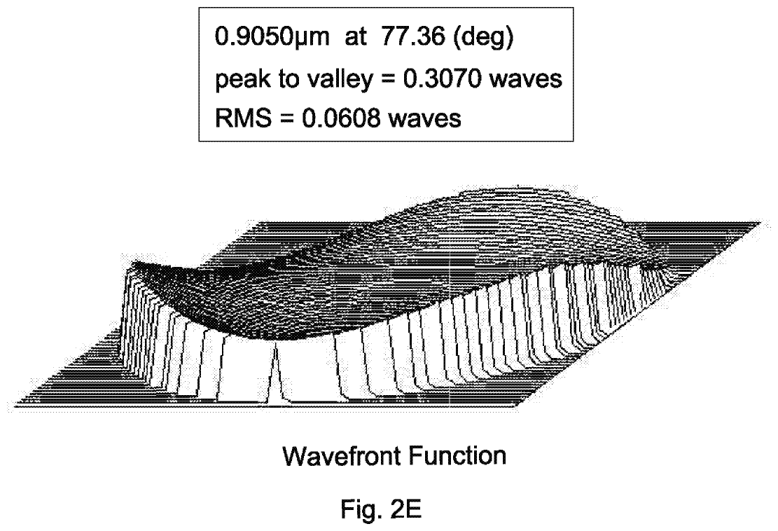

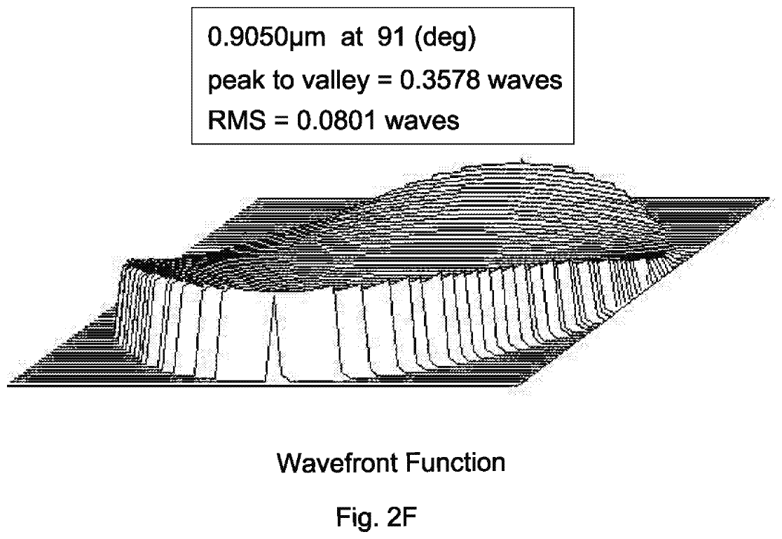

By the above arrangements of the lenses and stop ST1, the optical lens assembly 1 of the first embodiment can meet the requirements of optical performance as seen in FIGS. 2A-2F.

It can be seen from FIG. 2A that the peak to valley wavefront aberration is equal to 0.0271 waves and root mean square (RMS) wavefront aberration is equal to 0.0078 waves at an incident angle is equal to 0.00 degrees for the optical lens assembly 1 of the first embodiment.

It can be seen from FIG. 2B that the peak to valley wavefront aberration is equal to 0.1939 waves and RMS wavefront aberration is equal to 0.0364 waves at an incident angle is equal to 27.3 degrees for the optical lens assembly 1 of the first embodiment.

It can be seen from FIG. 2C that the peak to valley wavefront aberration is equal to 0.3682 waves and RMS wavefront aberration is equal to 0.0725 waves at an incident angle is equal to 45.5 degrees for the optical lens assembly 1 of the first embodiment.

It can be seen from FIG. 2D that the peak to valley wavefront aberration is equal to 0.2496 waves and RMS wavefront aberration is equal to 0.0549 waves at an incident angle is equal to 64.34 degrees for the optical lens assembly 1 of the first embodiment.

It can be seen from FIG. 2E that the peak to valley wavefront aberration is equal to 0.3070 waves and RMS wavefront aberration is equal to 0.0608 waves at an incident angle is equal to 77.36 degrees for the optical lens assembly 1 of the first embodiment.

It can be seen from FIG. 2F that the peak to valley wavefront aberration is equal to 0.3578 waves and RMS wavefront aberration is equal to 0.0801 waves at an incident angle is equal to 91 degrees for the optical lens assembly 1 of the first embodiment.

It is obvious that the wavefront aberration of the optical lens assembly 1 of the first embodiment can be corrected effectively. Therefore, the optical lens assembly 1 of the first embodiment is capable of good optical performance.

Referring to FIG. 3, FIG. 3 is a lens layout and optical path diagram of an optical lens assembly in accordance with a second embodiment of the invention. The optical lens assembly 2 includes a stop ST2, a first lens L21, a second lens L22, a third lens L23, a fourth lens L24, a fifth lens L25, a sixth lens L26 and a seventh lens L27, all of which are arranged in order from an object side to an image side along an optical axis OA2. In operation, a laser beam from the object side passes through the optical lens assembly 2 which leads spot size of the laser beam to be four times.

According to paragraphs [0030]-[0037], wherein: the fifth lens L25 is a plane-convex lens, wherein the image side surface S212 is a plane surface.

With the above design of the lenses and stop ST2 and at least any one of the conditions (1)-(9) satisfied, the optical lens assembly 2 can have an effectively shorten the total lens length, effectively increase field of view, effectively increase angle of incidence, effectively reduce angle of emergence, effectively reduce wavefront aberration, and effectively correct aberration.

Table 4 shows the optical specification of the optical lens assembly 2 in FIG. 3.

TABLE 4
Total Lens Length = 126.58 mm
Field of View = 91 Degrees
F-number = 1.62

| | | | | | Effec- | |
|---|---|---|---|---|---|---|
| | | | | | tive | |
| | Radius of | Thick- | | | Focal | |
| Surface | Curvature | ness | | | Length | |
| Number | (mm) | (mm) | Nd | Vd | (mm) | Remark |
| S21 | ∞ | 18.855 | | | | Stop ST2 |
| S22 | −81.88 | 8.8 | 2.00069 | 25.44 | 77.519 | The First |
| | | | | | | Lens L21 |
| S23 | −41.23 | 0.2 | | | | |
| S24 | 130.793 | 8 | 2.00069 | 25.44 | 109.579 | The Second |
| | | | | | | Lens L22 |
| S25 | −544.98 | 0.38 | | | | |
| S26 | 39.188 | 8.4 | 2.00069 | 25.44 | 166.363 | The Third |
| | | | | | | Lens L23 |
| S27 | 46.327 | 0.836 | | | | |
| S28 | 37.67 | 8.638 | 2.00069 | 25.44 | 120.315 | The Fourth |
| | | | | | | Lens L24 |
| S29 | 49.393 | 13.4 | | | | |
| S210 | ∞ | 37.01 | | | | Dummy |
| | | | | | | surface |
| S211 | −18.066 | 3 | 1.58913 | 61.16 | −31.159 | The Fifth |
| | | | | | | Lens L25 |
| S212 | ∞ | 7.22 | | | | |
| S213 | −39.069 | 15.39 | 2.00069 | 25.44 | 154.460 | The Sixth |
| | | | | | | Lens L26 |
| S214 | −36.98 | 6.5 | | | | |
| S215 | −400.509 | 8.806 | 2.00069 | 25.44 | 73.794 | The Seventh |
| | | | | | | lens L27 |
| S216 | −61.288 | 100 | | | | |

The definition of aspheric surface sag z of each aspheric lens in table 4 is the same as that of in Table 1, and is not described here again.

In the second embodiment, the conic constant k and the aspheric coefficients A, B, C, D of each aspheric surface are shown in Table 5.

TABLE 5

| Surface | | | | | |
|---|---|---|---|---|---|
| Number | k | A | B | C | D |
| S211 | −0.621 | −1.229E−005 | −2.356E−008 | −2.343E−012 | −2.174E−013 |

Table 6 shows the parameters and condition values for conditions (1)-(9) in accordance with the second embodiment of the invention. It can be seen from Table 6 that the optical lens assembly 2 of the second embodiment satisfies the conditions (1)-(9).

TABLE 6

| | | | | | | |
|---|---|---|---|---|---|---|
| AOI | 91 | degrees | AOE | 22.75 degrees | f₁₂₃₄ | 25.74 mm |
| f₅₆₇ | 101.19 | mm | | | | |

| | | | |
|---|---|---|---|
| AOE/ | 25% | f₅₆₇/f₁₂₃₄ | 3.93 |
| AOI | | | |

By the above arrangements of the lenses and stop ST2, the optical lens assembly 2 of the second embodiment can meet the requirements of optical performance.

In addition, the wavefront function diagram (figure is omitted) of the optical lens assembly 2 of the second embodiment approximate to that of the optical lens assembly 1 of the first embodiment, and the wavefront aberration of the optical lens assembly 2 of the second embodiment can be corrected effectively. Therefore, the optical lens assembly 2 of the second embodiment is capable of good optical performance.

Referring to FIG. 4, FIG. 4 is a lens layout and optical path diagram of an optical lens assembly in accordance with a third embodiment of the invention. The optical lens assembly 3 includes a stop ST3, a first lens L31, a second lens L32, a third lens L33, a fourth lens L34, a fifth lens L35, a sixth lens L36 and a seventh lens L37, all of which are arranged in order from an object side to an image side along an optical axis OA3. In operation, a laser beam from the object side passes through the optical lens assembly 3 which leads spot size of the laser beam to be four times.

According to paragraphs [0030]-[0037], wherein: the fifth lens L35 is a meniscus lenses, wherein the image side surface S312 is a plane surface and the image side surface S312 are aspheric surfaces.

With the above design of the lenses and stop ST3 and at least any one of the conditions (1)-(9) satisfied, the optical lens assembly 3 can have an effectively shorten the total lens length, effectively increase field of view, effectively increase angle of incidence, effectively reduce angle of emergence, effectively reduce wavefront aberration, and effectively correct aberration.

Table 7 shows the optical specification of the optical lens assembly 3 in FIG. 4.

TABLE 7
Total Lens Length = 126.73 mm
Field of View = 91 Degrees
F-number = 1.58

| | | | | | Effec- | |
|---|---|---|---|---|---|---|
| | | | | | tive | |
| | Radius of | Thick- | | | Focal | |
| Surface | Curvature | ness | | | Length | |
| Number | (mm) | (mm) | Nd | Vd | (mm) | Remark |
| S31 | ∞ | 18.855 | | | | Stop ST3 |
| S32 | −81.55 | 8.8 | 2.00069 | 25.44 | 77.519 | The First |
| | | | | | | Lens L31 |
| S33 | −41.23 | 0.2 | | | | |
| S34 | 129.16 | 8 | 2.00069 | 25.44 | 110.158 | The Second |
| | | | | | | Lens L32 |
| S35 | −593.54 | 0.38 | | | | |
| S36 | 39.19 | 8.4 | 2.00069 | 25.44 | 166.363 | The Third |
| | | | | | | Lens L3 3 |
| S37 | 46.33 | 0.84 | | | | |
| S38 | 37.67 | 8.64 | 2.00069 | 25.44 | 119.167 | The Fourth |
| | | | | | | Lens L34 |
| S39 | 49.62 | 13.401 | | | | |
| S310 | ∞ | 35.530 | | | | Dummy |
| | | | | | | surface |
| S311 | −19.206 | 3 | 1.589132 | 61.16 | −34.207 | The Fifth |
| | | | | | | Lens L35 |
| S312 | −642.126 | 7.22 | | | | |
| S313 | −34.21 | 16.51 | 2.00069 | 25.44 | 248.929 | The Sixth |
| | | | | | | Lens L36 |
| S314 | −37.07 | 6.5 | | | | |
| S315 | −304.78 | 9.31 | 2.00069 | 25.44 | 73.531 | The Seventh |
| | | | | | | lens L37 |
| S316 | −58.58 | 100 | | | | |

The definition of aspheric surface sag z of each aspheric lens in table 7 is the same as that of in Table 1, and is not described here again.

In the third embodiment, the conic constant k and the aspheric coefficients A, B, C, D of each aspheric surface are shown in Table 8.

TABLE 8

| Surface | | | | | |
|---|---|---|---|---|---|
| Number | k | A | B | C | D |
| S311 | −0.959 | −1.682E−005 | −3.448E−008 | −2.944E−011 | −1.215E−013 |
| S312 | −571.15 | 3.306E−006 | −1.077E−008 | 2.237E−011 | −1.697E−014 |

Table 9 shows the parameters and condition values for conditions (1)-(9) in accordance with the third embodiment of the invention. It can be seen from Table 9 that the optical lens assembly 3 of the third embodiment satisfies the conditions (1)-(9).

TABLE 9

| | | | | | | |
|---|---|---|---|---|---|---|
| AOI | 91 | degrees | AOE | 22.75 degrees | f₁₂₃₄ | 25.74 mm |
| f₅₆₇ | 101.00 | mm | | | | |

| | | | |
|---|---|---|---|
| AOE/ | 25% | f₅₆₇/f₁₂₃₄ | 3.92 |
| AOI | | | |

By the above arrangements of the lenses and stop ST3, the optical lens assembly 3 of the third embodiment can meet the requirements of optical performance.

In addition, the wavefront function diagram (figure is omitted) of the optical lens assembly 3 of the third embodiment approximate to that of the optical lens assembly 1 of the first embodiment, and the wavefront aberration of the optical lens assembly 3 of the third embodiment can be corrected effectively. Therefore, the optical lens assembly 3 of the third embodiment is capable of good optical performance.

In the field of lens design, the shape of any lenses will affect the exit angle of the incident laser beam, which in turn affects the spot size. When the surface shape of any one of the lenses is changed, in order to maintain the same spot size, the surface shape of other lenses also needs to be modified, that is, the surface shape of any one of the lenses can never be simply changed at will. The effect of all the embodiments of this invention on the spot size of the incident laser beam cannot be achieved by arbitrarily changing the shape of any lenses of the known optical lens assembly. The above overviews are intended to illustrate exemplary embodiments which will be best understood in conjunction with the detailed description to follow, and are intended to limit the scope or meaning of the independent claims.

This written description uses examples to disclose the invention, including the best mode, and also to enable any person skilled in the art to practice the invention, including making and using any devices or systems and performing any incorporated methods.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An optical lens assembly comprising:
a first lens which is with positive refractive power and comprises a convex surface facing an image side;
a second lens which is with positive refractive power and comprises a convex surface facing an object side;
a third lens which is a meniscus lens with refractive power;
a fourth lens which is with refractive power and comprises a convex surface facing the object side and a concave surface facing the image side;
a fifth lens which is with negative refractive power and comprises a concave surface facing the object side;
a sixth lens which is a meniscus lens with refractive power; and
a seventh lens which is a meniscus lens with positive refractive power;
wherein the first lens, the second lens, the third lens, the fourth lens, the fifth lens, the sixth lens and the seventh lens are arranged in order from the object side to the image side along an optical axis.

2. The optical lens assembly as claimed in claim 1, wherein the optical lens assembly satisfies 86.45 degrees≤FOV≤95.55 degrees, where FOV is a field of view of the optical lens assembly.

3. The optical lens assembly as claimed in claim 1,
wherein the optical lens assembly satisfies: any one of the Nd₁, Nd₂, Nd₃, Nd₄ Nd₆ and Nd₇ is greater than the Nd₅; and 23.75%≤AOE/AOI≤26.25%; wherein Nd₁ is an index of refraction of the first lens, Nd₂ is an index of refraction of the second lens, Nd₃ is an index of refraction of the third lens, Nd₄ is an index of refraction of the fourth lens, Nd₅ is an index of refraction of the fifth lens, Nd₆ is an index of refraction of the sixth lens, Nd₇ is an index of refraction of the seventh lens, AOI is an angle of incidence of the optical lens assembly, and AOE is an angle of emergence of the optical lens assembly.

4. The optical lens assembly as claimed in claim 1, wherein the optical lens assembly satisfies 3.8≤f₅₆₇/f₁₂₃₄≤4.2, where f₁₂₃₄ is an effective focal length of a combination of the first lens, the second lens, the third lens and the fourth lens and f₅₆₇ is an effective focal length of a combination of the fifth lens, the sixth lens, and the seventh lens.

5. The optical lens assembly as claimed in claim 1, wherein:
the first lens comprises a concave surface facing the object side;
the second lens comprises a convex surface facing the image side; and
the third lens is with positive refractive power and comprises a convex surface facing the object side and a concave surface facing the image side.

6. The optical lens assembly as claimed in claim 1, wherein:
the fourth lens is with positive refractive power;
the sixth lens is with positive refractive power and comprises a concave surface facing the object side and a convex surface facing the image side; and
the seventh lens comprises a concave surface facing the object side and a convex surface facing the image side.

7. The optical lens assembly as claimed in claim 1, wherein the fifth lens further comprises a concave surface facing the image side.

8. The optical lens assembly as claimed in claim 1, wherein the fifth lens further comprises a plane surface facing the image side.

9. An optical lens assembly comprising:
a first lens which comprises a convex surface facing an image side;
a second lens which is with positive refractive power and comprises a convex surface facing an object side;
a third lens which is a meniscus lens with refractive power;
a fourth lens which is a meniscus lens with refractive power;
a fifth lens which is with negative refractive power and comprises a concave surface facing the object side;
a sixth lens which is with refractive power and comprises a concave surface facing the object side and a convex surface facing the image side; and
a seventh lens which is with positive refractive power and comprises a convex surface facing an image side;
wherein the first lens, the second lens, the third lens, the fourth lens, the fifth lens, the sixth lens and the seventh lens are arranged in order from the object side to the image side along an optical axis.

10. The optical lens assembly as claimed in claim 9, wherein the optical lens assembly satisfies 86.45 degrees≤FOV≤95.55 degrees, where FOV is a field of view of the optical lens assembly.

11. The optical lens assembly as claimed in claim 9, wherein the optical lens assembly satisfies: any one of the Nd₁, Nd₂, Nd₃, Nd₄ Nd₆ and Nd₇ is greater than the Nd₅; and 23.75%≤AOE/AOI≤26.25% where Nd₁ is an index of refraction of the first lens, Nd₂ is an index of refraction of the second lens, Nd₃ is an index of refraction of the third lens, Nd₄ is an index of refraction of the fourth lens, Nd₅ is an index of refraction of the fifth lens, Nd₆ is an index of refraction of the sixth lens, Nd₇ is an index of refraction of the seventh lens, AOI is an angle of incidence of the optical lens assembly, and AOE is an angle of emergence of the optical lens assembly.

12. The optical lens assembly as claimed in claim 9, wherein the optical lens assembly satisfies 3.8≤f₅₆₇/f₁₂₃₄≤4.2, where f₁₂₃₄ is an effective focal length of a combination of the first lens, the second lens, the third lens and the fourth lens and f₅₆₇ is an effective focal length of a combination of the fifth lens, the sixth lens, and the seventh lens.

13. The optical lens assembly as claimed in claim 9, wherein:
the first lens is with positive refractive power and comprises a concave surface facing the object side;
the second lens comprises a convex surface facing the image side; and
the third lens is with positive refractive power and comprises a convex surface facing the object side and a concave surface facing the image side.

14. The optical lens assembly as claimed in claim 9, wherein:
the fourth lens is with positive refractive power and comprises a convex surface facing the object side and a concave surface facing the image side;
the sixth lens is with positive refractive power; and
the seventh lens comprises a concave surface facing the object side.

15. The optical lens assembly as claimed in claim 9, wherein the fifth lens further comprises a concave surface facing the image side.

16. The optical lens assembly as claimed in claim 9, wherein the fifth lens further comprises a plane surface facing image side.
